(19) United States
(12) Patent Application Publication
(10) Pub. No.: US 2025/0307539 A1
(43) Pub. Date: Oct. 2, 2025

(54) UNLEARNING DATA FROM LANGUAGE MODELS

(71) Applicant: Amazon Technologies, Inc., Seattle, WA (US)

(72) Inventors: Rahul Gupta, Waltham, MA (US); Anil K Ramakrishna, Culver City, CA (US); Kai-Wei Chang, Los Angeles, CA (US); Sankaranarayanan Ananthakrishnan, Belmont, MA (US)

(21) Appl. No.: 18/620,389

(22) Filed: Mar. 28, 2024

(51) Int. Cl. G06F 40/20

(52) U.S. Cl. CPC G06F 40/20

(57) ABSTRACT

Devices and techniques are generally described for unlearning information from large language models (LLMs). In various examples, a first language model (LM) trained on a first training corpus D may be determined. First data F that is a subset of D may be determined. A first auxiliary LM may be trained using the first training corpus D and a second auxiliary LM may be trained using a second training corpus D/F, where the second training corpus D/F represents the first training corpus D without the first data F. A first text input may be determined. The first LM may be updated based at least in part on a first prediction difference between predictions the first LM and the second auxiliary LM for a first set of inputs and a second prediction difference between the predictions of the first LM and the first auxiliary LM for the first set of inputs.

### BACKGROUND

People can interact with computing devices using spoken commands. In some systems, a “wakeword” is used to activate functionality. Natural language processing is used to transform the spoken requests that follow into a computer directive for performing a task. Some generative language models can generate natural sounding text in response to inputs.

### BRIEF DESCRIPTION OF DRAWINGS

FIGS. 1A-1C are block diagrams illustrating an example of unlearning data from language models (LMs) using auxiliary models, in accordance with various aspects of the present disclosure.

FIG. 2A depicts an example environment in which the system for unlearning data from language models of FIG. 1A may be deployed, in accordance with various aspects of the present disclosure.

FIG. 2B depicts an example LM-based natural language processing flow, in accordance with various aspects of the present disclosure.

FIG. 3 is a flow chart illustrating an example process for unlearning data from language models, in accordance with embodiments of the present disclosure.

FIG. 4 is a block diagram showing an example architecture of a network-connected device that may be used in accordance with various embodiments described herein.

FIG. 5 is a block diagram showing an example architecture of a computing device that may be used in accordance with various embodiments described herein.

### DETAILED DESCRIPTION

In the following description, reference is made to the accompanying drawings that illustrate several examples of the present invention. It is understood that other examples may be utilized and various operational changes may be made without departing from the scope of the present disclosure. The following detailed description is not to be taken in a limiting sense, and the scope of the embodiments of the present invention is defined only by the claims of the issued patent.

Devices with integrated processing capabilities are often configured with network communication capability and/or other computing functions allowing the devices to send data to and/or receive data from other devices. In some examples, such devices may include voice-enabled personal assistants and/or other natural language processing interfaces that may be used to control the devices, answer questions, communicate with other people/devices, and/or otherwise interact with the devices and/or other devices. As such devices become more and more prevalent in both the home, office, public spaces, quasi-public spaces (e.g., hotels, offices, retail spaces), and elsewhere generally, and as the technology matures, new services and features are being developed. For instance, in some cases devices may be paired or otherwise grouped together with one another to enable certain functionality. For example, a device that includes voice-based personal assistant functionality may be paired with a device including a display so that spoken commands may be used to control content output by the display device. In another example, content may be transferred from one device to another device in response to user requests and/or other triggering events (e.g., predefined user routines of actions, presence information, etc.).

Some natural language processing flows may employ one or more language models (LMs, such as large language models (LLMs)) in order to process natural language requests. An LM is an artificial intelligence (AI) model that may be capable of processing and generating human-like text based on the latent information it has learned from vast amounts of training data. The term “large” refers to the size of these models in terms of the number of parameters or weights, which are the values that the model learns during training to make predictions and generate text. LMs may have millions, billions (or even more) parameters, which enable such models to capture complex patterns and nuances in language that, in turn, allow the models to understand and generate more natural-sounding text (relative to previous approaches). Examples of LMs include the generative pre-trained transformer models and even non-generative examples such as BERT (bidirectional encoder representations from Transformers), etc.

In a generative context, an LM may generate text that is responsive to the input prompt provided to the LM. LMs excel at generating natural sounding text that appears as though it has been generated by a native speaker in the relevant language. In addition to fluency, generative LMs are able to generate detailed, relevant, and largely accurate responses to input prompts in many cases based on the parametric knowledge learned by the LM from the large amount of training data provided during training. In some cases, LMs and/or associated systems may retrieve context for a given input query (e.g., using an approach sometimes referred to as retrieval-augmented generation (RAG)), which may include information that may be useful for responding to the given input query. For example, if the input query is about the population of a specific country, a webpage describing information about the specific country may be retrieved and the content of the webpage may be provided in the LM prompt along with the input query.

As previously described LMs may be trained on massive datasets including publicly available information from the Internet. However, in some cases, stakeholders (e.g., individuals and/or entities) may request to have their data removed for a variety of reasons. For example, a copyright owner of a work (e.g., a written work, an artwork, etc.) may want to have their work removed from the training corpus of an LM. In some other examples, individuals may want to exercise their right to be forgotten (RTBF) and have any data related to them be removed from the model's parametric knowledge. Intuitively, such information can be “unlearned” from the LM by retraining the LM with an updated training corpus that excludes the identified information (e.g., the data to be removed or “unlearned”). However, in practice, such an approach is infeasible. Large LMs (LLMs) take large amounts of time and compute to train. For example, some current LLMs take months to train and the cost of the compute used to train such models extends into the millions of dollars. Accordingly, it is infeasible to re-train such models every time a “take-down” or unlearning request is received to remove some information from the model's learned parametric knowledge.

Described herein are novel systems and techniques that may be used for unlearning of specified information/data from LMs in a scalable way that does not sacrifice the performance of the LM and which does not require full retraining of the LM on the full training corpus minus the information to be unlearned. While many of the examples described herein discuss use of these unlearning techniques in the context of “LLMs” it should be noted that these techniques are applicable to language models of any size/any number of parameters. Considering a pre-trained LLM(D) trained on a training corpus D (e.g., text, text and images, etc., depending on the particular model), a user may request that their data F (a “forget set” of data), which is a subset of D, be unlearned by the LLM. However, as previously described, retraining the LLM on D/F (the training corpus D without the forget set F) is impractical due to computational cost/time. The goal of unlearning is to remove the influence of F from LLM(D) and to generate a model LLM\hat{ } that performs equivalently to LLM(D/F) (i.e., an LLM model trained on D/F).

LMs are typically trained on large datasets that may include a wide variety of text from various sources, enabling the LMs to understand information regarding a large variety of topics (covered by the training data) including grammar, context, and the relationships between words and sentences (collectively, this information may be referred to as the model's parametric knowledge). In various examples described herein, a natural language processing flow may employ a LM to process a natural language request. In some examples, an LM-based natural language processing flow may generate a prompt from automatic speech recognition (ASR) output data representing a spoken user utterance. The prompt may be fed into the LLM. In other examples, a text input (e.g., text typed on a keyboard) may be used as an input prompt (or may be used to generate an input prompt) to the LM. The LM may be trained to output a text-based action plan which may be a formatted into a series of computer-executable actions (including application programming interface (API) calls to various subsystems) that may be taken in order to process the natural language request. In various examples, an LM-based processing flow may be a recursive process wherein the initial action plan may be executed (e.g., by making various API calls to API providers to receive results/responses), and the responses may be used to generate updated LM prompts which may then be input into the LM for generation of an updated action plan. In some cases, a LM-based processing flow may not use NLU to determine intent data, and may not route intent and/or slot data (e.g., named entities) to a skill or other natural language processing system. Instead, the action plan generated by the LM-based processing flow may use a series of function calls to take the necessary actions used to respond to the natural language request.

Automatic speech recognition (ASR) is a field of computer science, artificial intelligence, and linguistics concerned with transforming audio data associated with speech into text data and/or other ASR output data representative of that speech. In a voice assistant context, such as those described herein, ASR may be used to transform spoken utterances into text that can then serve as the input to an LM or other language model (e.g., natural language understanding (NLU), which is a field of computer science, artificial intelligence, and linguistics concerned with enabling computers to derive meaning from text input containing natural language, resulting in specific executable command data (e.g., intent data) or other type of instructions). Text-to-speech (TTS) is a field of computer science, artificial intelligence, and linguistics concerned with enabling computers to output synthesized speech. ASR, language models (e.g., natural language generative models such as some LLMs), and TTS may be used together as part of a natural language processing system. As used in, natural language input data may comprise audio data (e.g., representing a user request or command), text data, and/or other representation data representing natural language for input into a natural language processing system.

The various techniques described herein may be used in a variety of contexts, including in natural language processing enabled devices (e.g., devices employing voice control and/or speech processing “voice assistants”) and/or systems.

Natural language processing enabled devices may include one or more microphones (e.g., far-field microphone arrays) used to transform audio into electrical signals. Speech processing may then be performed, either locally by the speech processing enabled device, by one or more other computing devices communicating with the speech processing enabled device over a network, or by some combination of the natural language processing enabled device and the one or more other computing devices. In various examples, natural language processing enabled devices may include and/or may be configured in communication with speakers and/or displays effective to output information obtained in response to a user's spoken request or command, and/or to output content that may be of interest to one or more users.

Storage and/or use of data related to a particular person or device (e.g., device identifier data, device names, names of device groups, contextual data, and/or any personal data) may be controlled by a user using privacy controls associated with a speech processing enabled device and/or a companion application associated with a speech processing enabled device. Users may opt out of storage of personal, device state (e.g., a paused playback state, etc.), and/or contextual data and/or may select particular types of personal, device state, and/or contextual data that may be stored while preventing aggregation and storage of other types of personal, device state, and/or contextual data. Additionally, aggregation, storage, and use of personal, device state, and/or contextual information, as described herein, may be compliant with privacy controls, even if not legally subject to them. For example, personal, contextual, device state, and other data described herein may be treated as if it was subject to acts and regulations, such as the Health Insurance Portability and Accountability Act (HIPAA) and the General Data Protection Regulation (GDPR), even if it is not actually subject to these acts and regulations. In various examples, the device and/or device group names and/or any data captured by such devices may be used only in accordance with user permission, in compliance with any relevant laws and/or policies. Additionally, users may opt out of data collection, and/or may opt to delete some or all of the data used by the various techniques described herein, even where deletion or non-collection of various data may result in reduced functionality and/or performance of various aspects of the systems described herein.

In various examples, a natural language processing enabled device may include a wakeword detection component. The wakeword detection component may process audio data captured by microphones of the speech processing enabled device and may determine whether or not a keyword and/or phrase, which are collectively sometimes referred to herein as a “wakeword”, is detected in the audio data. In some examples, when a wakeword is detected, the speech processing enabled device may enter a “sending mode,” “audio capturing mode,” and/or other type of processing mode in which audio detected by the microphones following the wakeword (e.g., data representing user request data spoken after the wakeword) may be sent to natural language processing computing component(s) (either locally or remotely) for further natural language processing (e.g., ASR, NLU, LLM inference, etc.). In various examples, the wakeword detection component may be used to distinguish between audio that is intended for the natural language processing system and audio that is not intended for the natural language processing system.

Machine learning techniques, such as those described herein, are often used to form predictions, solve problems, recognize objects in image data for classification, etc. In various examples, machine learning models may perform better than rule-based systems and may be more adaptable as machine learning models may be improved over time by retraining the models as more and more data becomes available. Accordingly, machine learning techniques are often adaptive to changing conditions. Deep learning algorithms, such as neural networks, are often used to detect patterns in data and/or perform tasks.

Generally, in machine learned models, such as neural networks, parameters control activations in neurons (or nodes) within layers of the machine learned models. The weighted sum of activations of each neuron in a preceding layer may be input to an activation function (e.g., a sigmoid function, a rectified linear units (ReLu) function, etc.). The result determines the activation of a neuron in a subsequent layer. In addition, a bias value can be used to shift the output of the activation function to the left or right on the x-axis and thus may bias a neuron toward activation.

Generally, in machine learning models, such as neural networks, after initialization, annotated training data may be used to generate a cost or “loss” function that describes the difference between expected output of the machine learning model and actual output. The parameters (e.g., weights and/or biases) of the machine learning model may be updated to minimize (or maximize) the cost. For example, the machine learning model may use a gradient descent (or ascent) algorithm to incrementally adjust the weights to cause the most rapid decrease (or increase) to the output of the loss function. The method of updating the parameters of the machine learning model is often referred to as back propagation.

Transformer models are machine learning models that include an encoder network and a decoder network. LLMs are often implemented using transformer models. The encoder takes an input (e.g., a “prompt”) and generates feature representations (e.g., feature vectors, feature maps, etc.) of the input. The feature representation is then fed into a decoder that may generate an output based on the encodings. In natural language processing, transformer models take sequences of words as input. A transformer may receive a sentence and/or a paragraph (or any other quantum of text) comprising a sequence of words as an input.

The encoder network of a transformer comprises a set of encoding layers that processes the input data one layer after another. Each encoder layer generates encodings (referred to herein as “tokens”). These tokens include feature representations (e.g., feature vectors and/or maps) that include information about which parts of the input data are relevant to each other. Each encoder layer passes its token output to the next encoder layer. The decoder network takes the tokens output by the encoder network and processes them using the encoded contextual information to generate an output (e.g., the aforementioned one-dimensional vector of tokens). The output data may be used to perform task-specific functions (e.g., action plan generation for an LLM-based natural language processing flow, etc.). To encode contextual information from other inputs (e.g., combined feature representation), each encoder and decoder layer of a transformer uses an attention mechanism, which for each input, weighs the relevance of every other input and draws information from the other inputs to generate the output. Each decoder layer also has an additional attention mechanism which draws information from the outputs of previous decoders, prior to the decoder layer determining information from the encodings. Both the encoder and decoder layers have a feed-forward neural network for additional processing of the outputs, and contain residual connections and layer normalization steps.

### Scaled Dot-Product Attention

The basic building blocks of the transformer are scaled dot-product attention units. When input data is passed into a transformer model, attention weights are calculated between every token simultaneously. The attention unit produces embeddings for every token in context that contain information not only about the token itself, but also a weighted combination of other relevant tokens weighted by the attention weights.

Concretely, for each attention unit the transformer model learns three weight matrices; the query weights W_{Q}, the key weights W_{K}, and the value weights W_{V}. For each token i, the input embedding xᵢ is multiplied with each of the three weight matrices to produce a query vector qᵢ=xᵢ W_{Q}, a key vector kᵢ=xᵢ W_{K}, and a value vector vᵢ=xᵢ W_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training. The attention weights are then passed through a softmax layer that normalizes the weights to sum to 1. The fact that W_{Q} and W_{K} are different matrices allows attention to be non-symmetric: if token i attends to token j, this does not necessarily mean that token j will attend to token i. The output of the attention unit for token i is the weighted sum of the value vectors of all tokens, weighted by aᵢⱼ, the attention from i to each token.

The attention calculation for all tokens can be expressed as one large matrix calculation, which is useful for training due to computational matrix operation optimizations which make matrix operations fast to compute. The matrices Q, K, and V are defined as the matrices where the ith rows are vectors qᵢ, kᵢ, and vᵢ respectively.

$$Attention ( Q , K , V ) = softmax ( \frac{{QK}^{T}}{\sqrt{{d}_{k}}} ) V$$

### Multi-Head Attention

One set of (W_{Q}, W_{K}, W_{V}) matrices is referred to herein as an attention head, and each layer in a transformer model has multiple attention heads. While one attention head attends to the tokens that are relevant to each token, with multiple attention heads the model can learn to do this for different definitions of “relevance.” The relevance encoded by transformers can be interpretable by humans. For example, in the natural language context, there are attention heads that, for every token, attend mostly to the next word, or attention heads that mainly attend from verbs to their direct objects. Since transformer models have multiple attention heads, they have the possibility of capturing many levels and types of relevance relations, from surface-level to semantic. The multiple outputs for the multi-head attention layer are concatenated to pass into the feed-forward neural network layers.

Each encoder comprises two major components: a self-attention mechanism and a feed-forward neural network. The self-attention mechanism takes in a set of input encodings from the previous encoder and weighs their relevance to each other to generate a set of output encodings. The feed-forward neural network then further processes each output encoding individually. These output encodings are finally passed to the next encoder as its input, as well as the decoders.

The first encoder takes position information and embeddings of the input data as its input, rather than encodings. The position information is used by the transformer to make use of the order of the input data. In various examples described herein, the position embedding may describe an order of a sequence of words.

Each decoder layer comprises three components: a self-attention mechanism (e.g., scaled dot product attention), an attention mechanism over the encodings, and a feed-forward neural network. The decoder functions in a similar fashion to the encoder, but an additional attention mechanism is inserted which instead draws relevant information from the encodings generated by the encoders. In a self-attention layer, the keys, values and queries come from the same place-in the case of the encoder, the output of the previous layer in the encoder. Each position in the encoder can attend to all positions in the previous layer of the encoder. In “encoder-decoder attention” layers (sometimes referred to as “cross-attention”), the queries come from the previous decoder layer, and the keys and values come from the output of the encoder. This allows every position in the decoder to attend over all positions in the input sequence. The decoder is attending to the encoder features.

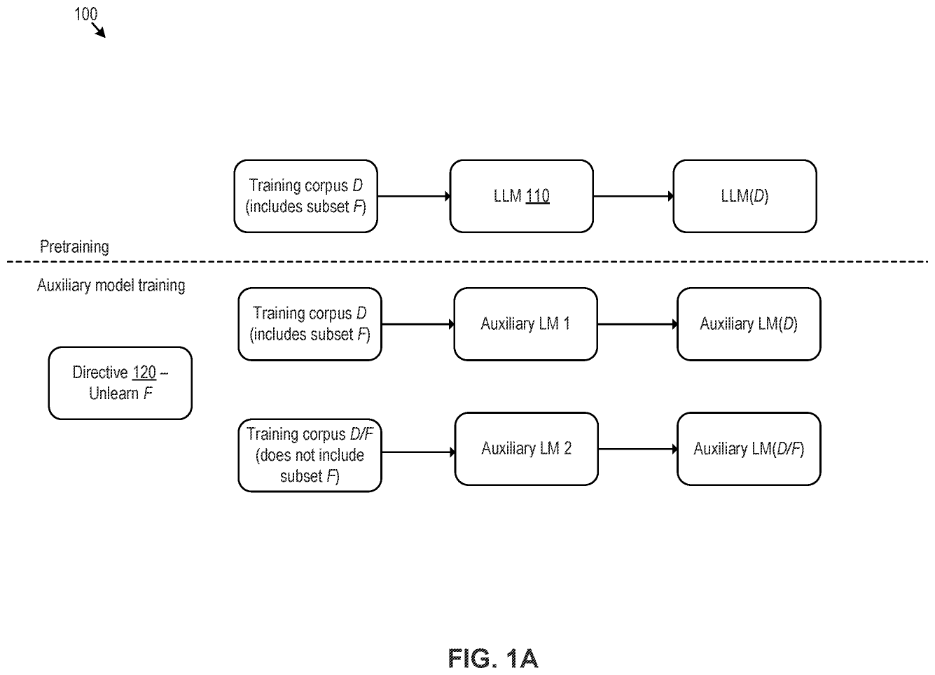

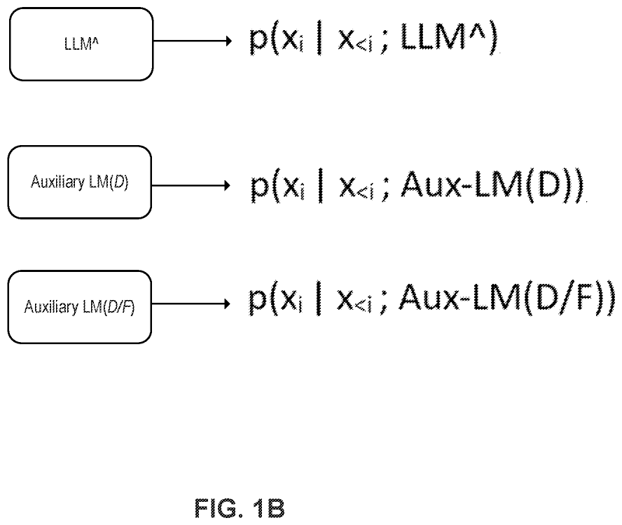

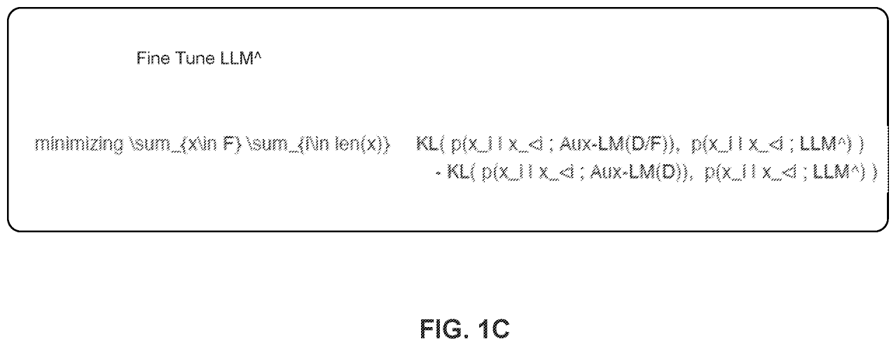

FIGS. 1A-1C are block diagrams illustrating an example of unlearning data from language models (LMs) using auxiliary models, in accordance with various aspects of the present disclosure. In the example system for unlearning data from language models 100 depicted in FIG. 1A, an LLM 110 may initially be pre-trained on the training corpus D (which includes the forget set F) to generate the trained model LLM(D). Thereafter, a directive 120 may be received to have the LLM(D) unlearn F.

Prior to describing the various techniques that may be used to unlearn F, evaluation metrics are first described that may be used to evaluate performance of the LLM 110. LLM\hat{ } refers to an LLM that has been modified to unlearn F, as described in further detail below.

| Evaluation | Type | Additional Dataset? | Expectation |
|---|---|---|---|
| KL divergence | Intrinsic | No | KL is small in all |
| between LLM(D/F), | | | cases (in F, in D, out |
| LLM\hat{ } | | | of D) |
| Perplexity of LLM\hat{ } | Intrinsic | No | PPL of LLM\hat{ } is as |
| similar to perplexity | | | high as LLM(D/F) in |
| of LLM(D/F) | | | F; is as low as |
| | | | LLM(D/F) in D/F or |
| | | | out of D |
| Accuracy on | Extrinsic | Yes | Accuracy of LLM\hat{ } is |
| automatically- | | | as low as LLM(D/F) |
| generated Q&A pairs | | | in Q&A generated |
| | | | form F; is as high as |
| | | | LLM(D/F) on that |
| | | | from D/F or out of D |
| Memorization suffix | Extrinsic | No | Given a prefix from |
| attacks | | | F, the probability of |
| | | | LLM\hat{ } generating |
| | | | exactly the same |
| | | | sequence as in F is |
| | | | low |

Intrinsic Evaluation on Comparing Distribution with a Reference Model

The goal of unlearning may be to minimize the difference between LLM\hat{ } and LLM(D/F). Let p(x_i|x_<i;LLM\hat{ }) represent the distribution of the output generated by LLM\hat{ } at position i for input x. Given a data set D_test, the performance of model LLM\hat{ } can be measured by the average Kullback-Leibler (KL) distance between LLM\hat{ } and LLM(D/F):

$$avg\_ \{ x ∖ in D\_test \} avg\_ \{ i ∖ in len ( x ) \} KL ( P ( x\_i \vert x\_ < i ; LLM ( D / F ) ) , p ( x\_i \vert x\_ < i ; {LLM}^{⋀} ) )$$

In various examples, D_test can be documents in forget set F, documents in D/F, or documents out of D. In any case, LLM\hat{ } and LLM(D/F) should produce similar distributions if unlearning is successful. Note that LLM(D/F) may not be feasible in all cases due to costs/time associated with re-training a large model on the dataset D/F.

### Extrinsic Evaluation on Downstream Performance

Another type of evaluation metric may be to compare the downstream performance of LLM\hat{ } with LLM(D/F) on a test dataset. Specifically, the performance of unlearning may be measured as the following:
1. On evaluation of F, LLM\hat{ } should perform as badly as LLM(D/F) as LLM\hat{ } has not seen F during training.
2. On evaluation on D/F or documents not in D, LLM\hat{ } should perform as well as LLM(D/F) or LLM(D).

The performance of the LLM may be measured using perplexity (testing how the LLM fits data), Q&A (testing if the information is retained), LLM benchmarks (by testing if the LLM retains its utility), and/or memorization suffix attacks.

### Unlearning Approaches

Some unlearning approaches consider the classification setting, where the goal is to remove the association between input and output labels learned from certain data. Such approaches may assume the label space is small (e.g., multi-class classification). Such approaches (e.g., influence function unlearning, Fisher unlearning, etc.) may be popular; however, such approaches cannot be directly adapted to unlearn large language models due to the scale of the output space and the size of the models. Some other approaches (e.g., in-context unlearning) consider removing specific knowledge learned by LLMs and injecting noisy examples to confuse the models. However, these approaches only hide the information, but do not cause the model to unlearn the specified information. Additionally, such approaches can only be applied to unlearn specific knowledge rather than removing the influence of training documents from the trained models.

One approach for LM unlearning is to minimize inverse LM loss (e.g., gradient ascent) on the target unlearned documents in F. By reversing the gradient direction for language modeling, the model learns to generate outputs different from F. While such an approach may help the LM to unlearn the information in F, it often leads to decreased overall performance of the LM. Additionally, the optimization objective is unbounded. A variant of inverse LM loss is gradient difference (Grad_Diff). Grad_Diff minimizes inverse LM loss on F while minimizing LM loss on D/F. Effectively, it fine-tunes on D/F while unlearning from F.

Another approach for LM unlearning is inverse LM loss with KL regularization. This approach uses reverse LM loss (e.g., gradient ascent on LM loss), random mismatch loss to guide the model to output random outputs, and KL divergence between the unlearned model and the original model (or reference model) to maintain LM performance.

One technical issue with the above-described LM unlearning approaches is that F includes not only specific information (e.g., the events, descriptions, stories, etc., present in F), but also general information and statistics (e.g., English grammar, common knowledge, etc.). By unlearning F from LLM(D), both types of information are removed, resulting in performance drop. While fine-tuning on D/F and KL regularizer can mitigate the issue, the conflict in learning objectives may confuse the LM and may lead to slower convergence during training.

Described herein are approaches that guide the unlearning of larger LMs (e.g., LLM 110) with smaller language models (e.g., auxiliary LM 1 and auxiliary LM 2 in FIG. 1A). In order to identify the information in the forget set F that is unique in LM (F) (e.g., a language model trained on F), the differences between LMs trained with and without F may be determined. As previously described, training an LLM (e.g., LLM 110) on D/F is not practical (as it may take months and be prohibitive in terms of compute cost), smaller auxiliary LMs (Aux-LM) may be trained to observe the differences between LMs trained with and without F. Difference architectures of the auxiliary LMs are now described by way of example.

N-Gram LM: An N-gram LM indexes the statistics of n-grams (words and/or portions of words (e.g., lemmatized and/or stemmed tokens, etc.)) in training data and may use maximum likelihood estimation (MLE) to estimate probability of generated outputs. Due to the properties of N-gram LMs, unlearning is trivial as it can be done by simply subtracting out the corresponding statistics of F from the model. Moreover, n-gram LMs can be scaled up to handle trillions of tokens, making n-gram LMs attractive for use in this context.

LLM trained on green data: Low-risk data sources G may be identified (e.g., books published more than 95 years ago that are not under copyright protection, licensed data, etc.) and used to train a “green” LM (e.g., LLM(G)) as the auxiliary LM. One issue with this approach may be that the domain and distribution of G and D may be different, leading to misalignment between LLM(D) and LLM(G).

LLMs on partitions of data: D may be split into multiple partitions and each partition may be used to train a respective LM. Then, an aggregation of models trained on data without F may be used as the auxiliary LM.

Smaller LLM: a smaller-sized LLM may be trained (e.g., a LM with at least an order of magnitude fewer parameters relative to LLM(D)). In this case, retraining the smaller model on D/F may be possible and this may be used to guide the large LLM. However, this approach may not be practical if there are frequent unlearning requests.

Once an Aux-LM is selected, the difference between Aux-LM(D) and Aux-LM(D/F) can be used to guide the LLM (e.g., through fine-tuning). Specifically, F can be unlearned by minimizing the prediction difference between the LLM (the LLM 110 being fine-tuned to generate LLM\hat{ }) and Aux-LM(D/F) while maximizing the prediction difference between the LLM and Aux-LM(D) for the forget set F. Formally, Equation (1) may be:

$$minimizing ∖ sum\_ \{ x ∖ in F \} ∖ sum\_ \{ i ∖ in len ( x ) \} KL ( p ( x\_i \vert x\_ < i ; Aux - LM ( D / F ) ) , p ( x\_i \vert x\_ < i ; {LLM}^{⋀} ) ) - KL ( p ( x\_i \vert x\_ < i ; Aux - LM ( D ) ) , p ( x\_i \vert x\_ < i ; {LLM}^{⋀} ) )$$

As shown in FIG. 1A, two versions of the Aux-LM may be trained-a first version may be trained on D to generate Aux-LM(D) and a second version may be trained on D/F to generate Aux-LM(D/F). Since the auxiliary LMs may be at least an order of magnitude smaller (e.g., in terms of the number of learnable parameters) relative to the LLM 110, it may be practicable to train these models on the training sets D and D/F. It should be noted that while Equation (1) (and FIG. 1C) describe use of KL divergence, any divergence metric may be used, as desired. For example, the Jensen-Shannon divergence, Renyi divergence, or the like may be used in place of KL divergence.

As shown in FIG. 1B, p(x_i|x_<i;LLM\hat{ }) may be the probability of generating token x_i (e.g., xᵢ) given the previous token(s) x_<i by the LLM\hat{ } (e.g., the LLM being fine-tuned). Similarly, p(x_i|x_<i; Aux-LM(D) may be the probability of generating token x_i (e.g., xᵢ) given the previous token(s) x_<i by the auxiliary model trained on D (Aux-LM(D)) and p(x_i|x_<i; Aux-LM(D/F)) may be the probability of generating token x_i (e.g., xᵢ) given the previous token(s) x_<i by the auxiliary model trained on D/F (Aux-LM(D/F)). As shown in FIG. 1C, the LLM\hat{ } may be generated by fine-tuning the LLM pretrained on D using equation (1). This loss may be determined over the predefined set F. The loss function represented by equation (1) may be used to fine-tune the LLM 110 to generate LLM\hat{ } quickly without training a model LLM(D/F). LLM\hat{ } may effectively unlearn the forget set F while retaining its utility/performance for D/F.

In various examples, a reinforcement learning approach may be used with a learning policy that includes a reward term that rewards the LLM (e.g., LLM 110 that is being updated to unlearn F) for generating outputs that are statistically similar to outputs of Aux-LM(D/F) and a penalty term that penalizes the LLM for generating outputs that are statistically similar to outputs of the Aux-LM(D) for a given input. Statistical similarity may be determined using any desired statistical similarity metric (e.g., a distance-based metric, cosine similarity, Jaccard similarity, etc.).

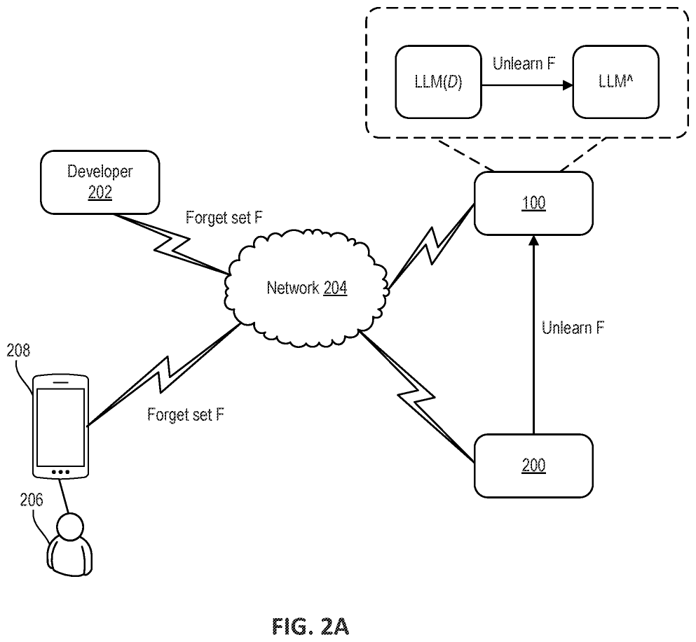

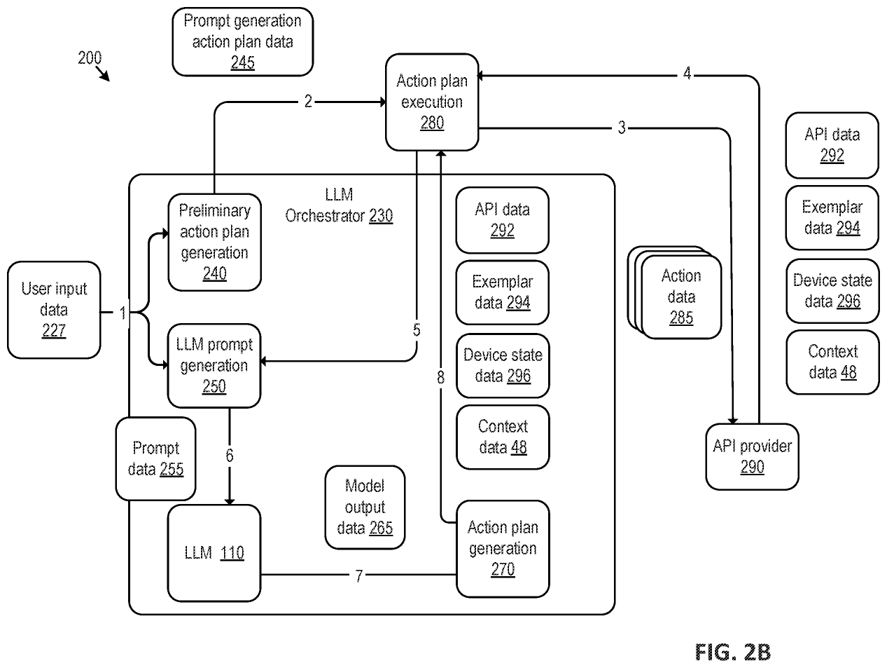

FIG. 2A depicts an example environment in which the system for unlearning data from language models 100 may be deployed, in accordance with various aspects of the present disclosure. As shown, a developer device 202, a user device 208 (associated with a user 206), etc., may communicate over a computer communications network 204 (e.g., a wide area network such as the Internet) with the system for unlearning data from language models 100. For example, the user 206 and/or a developer associated with the developer device 202 may want a particular language model employed by the LLM-based natural language processing system 200 to unlearn a forget set of data F.

In various examples, the LLM-based natural language processing system 200 may receive the request for an LM maintained by the LLM-based natural language processing system 200 to unlearn the forget set F. The LLM-based natural language processing system 200 may call the system for unlearning data from language models 100 using an API associated with the system for unlearning data from language models 100. The forget set F may be sent to the system for unlearning data from language models 100 so that the system is possessed of the data to be unlearned. Thereafter, the system for unlearning data from language models 100 may fine tune the LM (updating learnable parameters of the LM) using the techniques previously described to unlearn the information in F.

Although the example in FIG. 2A involves the LLM-based natural language processing system 200 as the system that maintains the subject LM for which Fis to be unlearned, it should be noted that any custodian of an LM (e.g., an owner and/or maintainer of an LM) may use the system for unlearning data from language models 100. In some examples, the system maintaining the LM (LLM-based natural language processing system 200 in the example of FIG. 2A) may incorporate the system for unlearning data from language models 100. In such cases, using the system for unlearning data from language models 100 to unlearn data may not require an API call to an external service.

FIG. 2B depicts an example LLM-based natural language processing system 200 (e.g., of LLM 110 described above), in accordance with various aspects of the present disclosure. The LLM-based natural language processing flow of FIG. 2B may be used, for example, by a virtual assistant and/or may be part of a foundational model that may be integrated into various systems and/or applications to improve functionality and/or usability. As previously described, in some instances, the LLM 110 may be trained over on a large training corpus over a relatively long period of time and using a large amount of computational resources. Subsequent to the training of LLM 110, a forget set F may be specified for unlearning. It may be infeasible to retrain the LLM 110 on its original training corpus (e.g., D) less the forget set F (e.g., D/F). Accordingly, the techniques described above may be used to fine-tune the LLM 110 to unlearn F without while saving time (on the order of months) and computational resources. These unlearning techniques may be especially useful in the face of repeated forget sets F, such as when multiple RTBF requests are received over a period of time.

Various examples of the LLM-based natural language processing flow are now described for illustrative purposes. Various components described in reference to FIG. 1 may be included in the architecture of FIG. 2B although they may not be specifically shown in the example. The example architecture in FIG. 2B includes an LLM orchestrator 230 and various other components for determining an action responsive to a user input. The architecture may further include an action plan execution component 280 and an application programming interface (API) provider component 290. With reference to FIG. 2B, the LLM orchestrator 230 may include a preliminary action plan generation component 240, a LLM prompt generation component 250, an LLM 110, and an action plan generation component 270. In various examples, the LLM 110 may be a generative model and data may be unlearned from the LLM 110 by fine-tuning the LLM 110 using the system for unlearning data from language models 100.

In some examples, the LLM 110 may be a transformer-based seq2seq model involving an encoder-decoder architecture. In some such embodiments, the LLM 110 may be a multilingual (approximately) 20 billion parameter seq2seq model that is pre-trained on a combination of denoising and Causal Language Model (CLM) tasks in various languages (e.g., English, French, German, Arabic, Hindi, Italian, Japanese, Spanish, etc.), and the LLM 110 may be pre-trained with approximately 1 trillion tokens. Being trained on CLM tasks, the LLM 110 may be capable of in-context learning. An example of such a LLM is Alexa Teacher Model (Alexa™).

In various examples, the input to the LLM 110 may be in the form of a prompt. A prompt may be a natural language input, for example, an instruction, for the LLM 110 to generate an output according to the prompt. The output generated by the LLM 110 may be a natural language output responsive to the prompt. The prompt and the output may be text in a particular spoken language. For example, for an example prompt “how do I cook beans?”, the LLM 110 may output a recipe (e.g., a step-by-step process) to cook beans. As another example, for an example prompt “I am hungry. What restaurants in the area are open?”, the LLM may output a list of restaurants near the user that are open at the current time.

The LLM 110 may be configured using various learning techniques. For example, in some embodiments, the LLM 110 may be configured (e.g., “fine tuned”) using few-shot learning. In few-shot learning, the model learns how to learn to solve the given problem. In this approach, the model is provided with a limited number of examples (i.e., “few shots”) from the new task, and the model uses this information to adapt and perform well on that task. Few-shot learning may require fewer amount of training data than implementing other fine-tuning techniques. For further example, in some embodiments, the LLM 110 may be configured using one-shot learning, which is similar to few-shot learning, except the model is provided with a single example. As another example, in some embodiments, the LLM 110 may be configured using zero-shot learning. In zero-shot learning, the model solves the given problem without examples of how to solve the specific/similar problem and just based on the model's training dataset. In this approach, the model is provided with data sampled from a class not observed during training, and the model learns to classify the data.

The LLM orchestrator 230 may be configured for generating the prompt to be used by the LLM 110 to determine an action responsive to a user input. As shown in FIG. 2B, the LLM orchestrator 230 receives (at step 1) user input data 227. In some instances, the user input data 227 may correspond to a text or tokenized representation of a user input. For example, prior to the LLM orchestrator 230 receiving the user input data 227, another component (e.g., an ASR component) may receive audio data representing the user input. The ASR component may perform ASR processing on the audio data to determine ASR output data corresponding to the user input. As previously described, the ASR component may determine ASR data that includes an ASR N-best list including multiple ASR hypotheses and corresponding confidence scores representing what the user may have said. The ASR hypotheses may include text data, token data, etc. as representing the input utterance. The confidence score of each ASR hypothesis may indicate the ASR component's level of confidence that the corresponding hypothesis represents what the user said. The ASR component may also determine token scores corresponding to each token/word of the ASR hypothesis, where the token score indicates the ASR component's level of confidence that the respective token/word was spoken by the user. The token scores may be identified as an entity score when the corresponding token relates to an entity. In some instances, the user input data 227 may include a top scoring ASR hypothesis of the ASR data.

As illustrated in FIG. 2B, the user input data 227 may be received at the preliminary action plan generation component 240 and the LLM prompt generation component 250 of the LLM orchestrator 230. The preliminary action plan generation component 240 processes the user input data 227 to generate prompt generation action plan data 245 corresponding to an instruction(s) (e.g., a request(s)) for one or more portions of data usable to generate a language model prompt for determining an action responsive to the user input). In some examples, the one or more portions of data may be data that is determined to be relevant for processing of the user input. The one or more portions of data may represent one or more actions (e.g., API definitions), one or more exemplars corresponding to the actions (e.g., example model outputs including an appropriate use of the API), one or more device states corresponding to one or more devices associated with the user input, and/or one or more other contexts associated with the user input. For example, if the user input data 227 represents a user input of “please turn on the kitchen lights every morning at 7 am,” then the preliminary action plan generation component 240 may determine prompt generation action plan data 245 representing instructions for one or more actions (e.g., API definitions) related to turning on the kitchens lights every morning, one or more exemplars corresponding to the related actions, one or more device states corresponding to one or more devices associated with the “kitchen lights”, and one or more other contexts. For further example, if the user input data 227 represents a user input of “What is the elevation of Mt. Everest,” then the preliminary action plan generation component 240 may determine prompt generation action plan data 245 representing instructions for one or more actions (e.g., API definitions, specifications, schemas) related to the user input and one or more exemplars corresponding to the related actions, as other information, such as devices states or other contextual information (user profile information, device profile information, weather, time of day, historical interaction history) may not be relevant. The preliminary action plan generation component 240 may be used to determine relevant context 118 (e.g., context data 48) relevant to the user input query by calling one or more APIs as described below. In addition, the preliminary action plan generation component 240 may retrieve and/or generate the irrelevant context 114 (i.e., adversarial data) that may be included in a separate prompt relative to the prompt including the relevant context and the prompt used by the LLM 110 to respond to the input query.

In some examples, the prompt generation action plan data 245 may include one or more executable API calls usable for retrieving the one or more portions of data from the corresponding component. For example, instructions included in the prompt generation action plan data 245 may include “FETCH_API,” “FETCH_EXEMPLAR,” “FETCH_DEVICE_STATE,” “FETCH_CONTEXT,” etc., along with optional API arguments/inputs. In some embodiments, the prompt generation action plan data 245 may also include the user input data 227. The prompt generation action plan data 245 may be sent (at step 2) to the action plan execution component 280.

In some examples, the preliminary action plan generation component 240 may be configured to process the user input data 227 to determine a representation of the user's request. In various examples, the representation of the user's request may be a reformulation of the user's request. For example, the if the user input data 227 represents a user input of “I have always wanted to travel to Japan, I have heard it's beautiful. How tall is Mt. Fuji?”, then the preliminary action plan generation component 240 may determine the representation of the user's request as being “How tall is Mt. Fuji,” or the like. The preliminary action plan generation component 240 may generate the prompt generation action plan data 245 using the determined representation of the user's request.

In some examples, the preliminary action plan generation component 240 may implement one or more machine learning (ML) models. A first ML model(s) may be configured to take as input the user input data 227 and generate a representation of the user's request. For example, the ML model may be a text summarization model or a text rewrite model. A second ML model (or the first ML model) may be configured to take as input the representation of the user's request (or the user input data 227) and determine the one or more portions of data relevant for processing of the user input. For example, the second ML model may be a classifier trained to classify the user's request (or the user input data 227) to determine data (or types of data) relevant to the processing of the user input (e.g., one or more related actions (e.g., API definitions), one or more exemplars corresponding to the one or more related actions, one or more device states corresponding to one or more related devices, one or more related contexts, etc.)

In other embodiments, the preliminary action plan generation component 240 may be an LLM, similar to the LLM 110. In such embodiments, the architecture (e.g., LLM 110) may include a further component configured to generate a prompt to be provided to the LLM (e.g., similar to the LLM prompt generation component 250) or the prompt may be generated by the LLM prompt generation component 250. The component may generate a prompt (e.g., according to a template) including the user input data 227 and instructions to determine the one or more portions of data (or types of data) relevant to the processing of the user input. The LLM may process the prompt and generate model output data representing the one or more portions of data (or types of data). The preliminary action plan generation component 240 may process the model output data to determine the prompt generation action plan data 245.

The action plan execution component 280 may process the prompt generation action plan data 245 to execute the one or more instructions to retrieve/receive data corresponding to the user input and that may be used to generate the language model prompt. As shown in FIG. 2B, the action plan execution component 280 processes the prompt generation action plan data 245 to generate action data 285 representing an action included in the prompt generation action plan data 245 (e.g., a single instruction, such as FETCH_CONTEXT). For example, in the situation where the action is represented by an API call, the action data 285 may represent the action plan execution component 280 executing the API call included in the prompt generation action plan data 245. The action data 285 may be sent (at step 3) to the API provider component 290. In the situation where the prompt generation action plan data 245 includes more than one instruction, the action plan execution component 280 may generate more than one instance of action data 285 (e.g., one instance for each instruction included in the prompt generation action plan data 245) and send each instance to the API provider component 290.

The API provider component 290 may process the (one or more instances of the) action data 285 and cause the retrieval of the (one or more portions of) data associated with the action data 285. The API provider component 290 may include a knowledge provider component. The knowledge provider component may include an API retrieval component, an exemplar retrieval component, a device state retrieval component, and an “other” context retrieval component. The knowledge provider component may provide the action data 285 to the component(s) configured to determine the data corresponding to the request(s) represented by the action data 285.

For example, the API retrieval component (not shown) may process the action data 285 to generate API data 292 representing one or more APIs that correspond to an action performable with respect to the user input. For example, if the user input corresponds to “turn on the kitchen light,” the API retrieval component may determine an API usable to control a device and include an API definition corresponding to the API in the API data 292. In some embodiments, the API definition may include one or more API call frameworks for instructing/requesting that the API perform an action (e.g., turn_on_device (device: [device name]), turn_off_device (device: [device name]), set_device_temperature (device: [device name]); temperature: [temperature], set_device_volume (device: [device name]; volume: [volume value]), etc.). In some embodiments, the API definition may include a natural language description of the functionality of the API (e.g., a natural language description of the actions performable by the API/API call framework). For example, for the abovementioned API determined to be associated with the user input of “turn on the kitchen light,” the API definition may further include a natural language description of “used to power on a device.” In some embodiments, the one or more API definitions may be included in the API data 292 based on them being semantically similar to the user input. For example, the API retrieval component may be capable of comparing (e.g., using cosine similarity) (an encoded representation of) the user input to (an encoded representation of) the API definition to determine a semantic similarity between the user input and the API definition (e.g., a semantic similarity between the user input and the natural language description of the functionality of the API included in the API definition). If the API definition is determined to be semantically similar to the user input, then the corresponding API definition may be included in the API data 292. In some embodiments, the API retrieval component may include the top-n identified API definitions in the API data 292. The API data 292 may be sent (at step 4) to the action plan execution component 280 as shown in FIG. 2B.

In some embodiments, the knowledge provider component may be configured to cause one or more of the API retrieval components, the exemplar retrieval component, the device state retrieval component, and the other context retrieval component to process based on the data output by one or more of the components of the knowledge provider component. For example, if the output of the API retrieval component (e.g., the API data 292) indicates that a related API definition was identified, then the knowledge provider component (or another component) may cause the exemplar retrieval component to process to determine one or more exemplars related to the identified API definitions. For further example, if the output of the API retrieval component (e.g., the API data 292) indicates that a particular API definition was identified (e.g., an API definition for controlling a device), then the knowledge provider component may cause the exemplar retrieval component to process as described above, and may further cause the device state retrieval component and/or the other context retrieval component to process to determine device states for one or more related devices and/or other contextual information based on the identified API definition being associated with controlling a device. In some embodiments, the knowledge provider component may determine to cause the components to process based on instruction(s) included in the action data (e.g., based on a determination made by preliminary action plan generation component 240, as discussed above).

The action plan execution component 280 may send (step 5) the data received from the API provider component 290 (e.g., the API data 292, the exemplar data 294, the device state data 296, and the other context data 48) to the LLM prompt generation component 250. The LLM prompt generation component 250 may be configured to generate prompt data 255 (e.g., using the user input data 227, the API data 292, the exemplar data 294, the device state data 296, and/or the other context data 48) to be used by the LLM 110.

In some examples, the LLM prompt generation component 250 may generate the prompt data 255 representing a prompt for input to the LLM 110. In some embodiments, such prompt data 255 may be generated based on combining the user input data 227, the API data 292, the exemplar data 294, the device state data 296, and the other context data 48. The prompt data 255 may be an instruction to determine an action(s) responsive to the user input data 227 given the other information (e.g., the API data 292, the exemplar data 294, the device state data 296, the other context data 48) included in the prompt data 255. In some embodiments, the LLM prompt generation component 250 may also include in the prompt data 255 a sample processing format to be used by the LLM 110 when processing the prompt and generating the response.

In some embodiments, the LLM prompt generation component 250 may also include in the prompt data an instruction to output a response that satisfies certain conditions. Such conditions may relate to generating a response that is unbiased (toward protected classes, such as gender, race, age, etc.), non-harmful, profanity-free, etc. For example, the prompt data may include “Please generate a polite, respectful, and safe response and one that does not violate protected class policy.”

The LLM 110 processes the prompt data 255 to generate model output data 265 representing an action responsive to the user input. For example, based on processing the example prompt data provided above, the LLM 110 may output model output data 265: {“Thought: the user is trying to turn on the living room light; Action: turn_on_device (device=“living room light”),”} or the like. The model output data 265 is sent (at step 7) to the action plan generation component 270. The action plan generation component 270 may parse the model output data 265 to determine action plan data representing the action generated by the LLM 110. For example, for the model output data 265: “Action: turn_on_device (device=“living room light”),” the corresponding action plan data may correspond to “turn_on_device (device=” living room light “)” (e.g., corresponding to the action generated by the LLM 110, without the label of “Action”). In some embodiments, the action plan generation component 270 may determine an API call corresponding to the “Action” data included in the model output data 265. For example, in some embodiments, the action plan generation component 270 may fill in the arguments/inputs, if any, for the API call, which may be included in the action plan data. For further example, in some embodiments, the action plan execution component 280 may fill in the arguments/inputs, if any, for the API call.

In some embodiments, the LLM orchestrator 230 (e.g., the action plan generation component 270 or another component of the LLM orchestrator 230) may determine whether the LLM 110 output satisfies certain conditions. Such conditions may relate to checking whether the output includes biased information (e.g., bias towards a protected class), harmful information (e.g., violence-related content, harmful content), profanity, content based on model hallucinations, etc. A model hallucination refers to when a model (e.g., a language model) generates a confident response that is not grounded in any of its training data. For example, the model may generate a response including a random number, which is not an accurate response to an input prompt, and then the model may continue to falsely represent that the random number is an accurate response to future input prompts. To check for an output being based on model hallucinations, the LLM orchestrator 230 may use a knowledge base, web search, etc. to fact-check information included in the output. The action plan may be sent to the action plan execution component 280 for execution (Step 8). In various examples, action plan generation component 270 and/or action plan execution component 280 may be implemented as the same logical system.

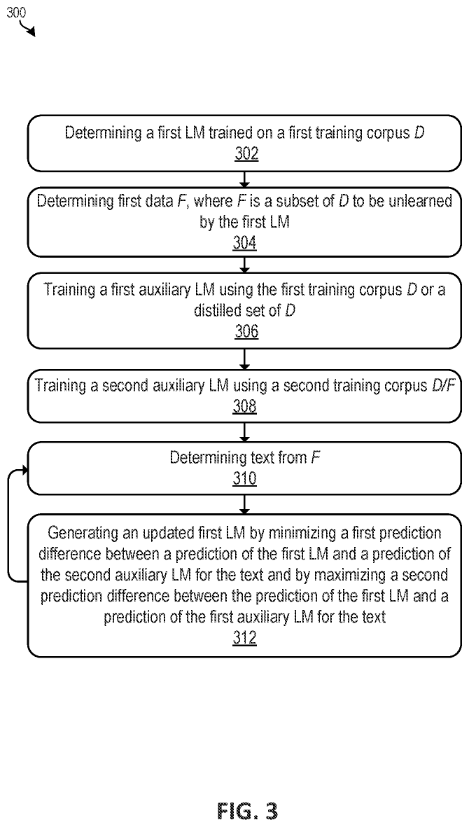

FIG. 3 is a flow chart illustrating an example process 300 for unlearning data from language models, in accordance with embodiments of the present disclosure. The process 300 of FIG. 3 may be executed by one or more computing devices. The actions of process 300 may represent a series of instructions comprising computer-readable machine code executable by a processing unit of a computing device. In various examples, the computer-readable machine code may be comprised of instructions selected from a native instruction set of the computing device and/or an operating system of the computing device. Various actions in process 300 may be described above with reference to elements of FIGS. 1-2. Although shown in a particular order, the steps of process 300 may instead be performed in a different order. Additionally, various steps may be performed in parallel in various implementations. Further, some steps may be omitted and/or other steps may be added in accordance with the language model unlearning techniques described herein.

Process 300 may begin at action 302, at which a first LM trained on a first training corpus D may be determined. The first LM may be any language model for which unlearning is to be performed (e.g., LLM 110). For example, an entity may want to have data owned by that entity unlearned by a particular LLM. The entity may specify the data to be unlearned (e.g., forget set F) and the model which should unlearn the data (e.g., LLM 110).

Processing may continue at action 304, at which the first data F may be determined. F may be a subset of D and may be the subset of data that is to be unlearned by the specified model (e.g., the first LM from action 302). In some examples, the forget set F may be specified by an entity that owns the data in the forget set F and wants to have this data unlearned by the first LM. In other examples, the forget set F may be data identified by an entity that owns/maintains the first LM. In any case, the entity identifying the forget set F is irrelevant to the learning techniques specified herein.

Processing may continue at action 306, at which a first auxiliary LM may be trained using the first training corpus D or a distilled set of D. The first auxiliary LM may be an n-gram LM and/or any LM that is at least an order of magnitude smaller (in terms of a number of learnable parameters) relative to the first LM. In various examples, the first auxiliary LM may be trained on the same training corpus as the first LM (e.g., the training corpus D). However, in other examples, in order to increase the speed of training, the first auxiliary LM may be trained on a representative subset of the set D (e.g., using known model distillation (sometimes referred to as “knowledge distillation”) techniques). As previously described, in some examples, the training set D may be partitioned and multiple auxiliary models may be trained-one auxiliary model on each partition of D. Thereafter, an aggregated model may be generated using the multiple auxiliary models trained on the partitions (e.g., by averaging parameter values).

Processing may continue at action 308, at which a second auxiliary LM may be trained using a second training corpus D/F. As described herein, the corpus D/F may be the training corpus D (or a distillation/partition thereof) less the forget set F. Processing may continue at action 310, at which text from F may be determined. Processing may continue at action 312, at which an updated first LM may be generated by minimizing a first prediction difference between a prediction of the first LM and a prediction of the second auxiliary LM for the text and by maximizing a second prediction difference between the prediction of the first LM and a prediction of the first auxiliary LM for the text. For example, Equation (1) above may be used to minimize the prediction difference between the first LM (e.g., LLM 110 that is being fine-tuned to generate LLM\hat{ }) and Aux-LM(D/F) while maximizing the prediction difference between the first LM and Aux-LM(D). During training, the gradient may be calculated from loss defined by Equation (1) and may be back-propagated to the first LM to update the parameters. The training process may be iterative and may iterate over the subset F until model convergence. FIG. 3 reflects the iterative nature of the training process by showing an arrow from action 312 to action 310.

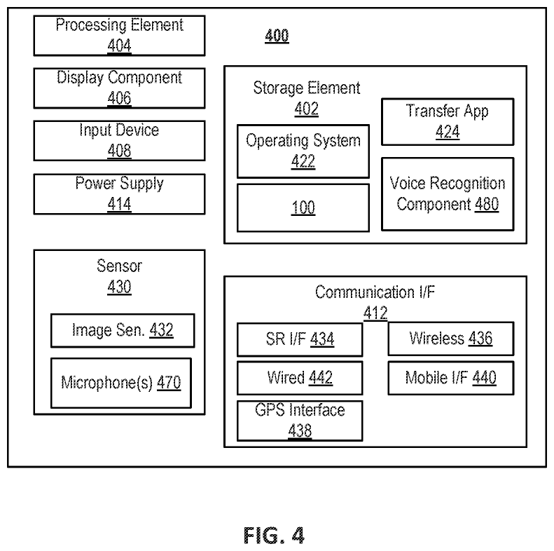

FIG. 4 is a block diagram showing an example architecture 400 of a network-connected device (e.g., a local network-connected device such as a natural language processing-enabled device or another input device) that may be used to implement, at least in part, a natural language processing-enable device configured to receive spoken and/or other natural input commands, in accordance with various aspects of the present disclosure. It will be appreciated that not all devices will include all of the components of the architecture 400 and some user devices may include additional components not shown in the architecture 400. The architecture 400 may include one or more processing elements 404 for executing instructions and retrieving data stored in a storage element 402. The processing element 404 may comprise at least one processor. Any suitable processor or processors may be used. For example, the processing element 404 may comprise one or more digital signal processors (DSPs). In some examples, the processing element 404 may be effective to determine a wakeword and/or to stream audio data to a speech processing system. The storage element 402 can include one or more different types of memory, data storage, or computer-readable storage media devoted to different purposes within the architecture 400. For example, the storage element 402 may comprise flash memory, random-access memory, disk-based storage, etc. Different portions of the storage element 402, for example, may be used for program instructions for execution by the processing element 404, storage of images or other digital works, and/or a removable storage for transferring data to other devices, etc. In various examples, the storage element 402 may comprise one or more components of the system for unlearning data from language models 100 for unlearning data from language models.

The storage element 402 may also store software for execution by the processing element 404. An operating system 422 may provide the user with an interface for operating the computing device and may facilitate communications and commands between applications executing on the architecture 400 and various hardware thereof. A transfer application 424 may be configured to receive images, audio, and/or video from another device (e.g., a mobile device, image capture device, and/or display device) or from an image sensor 432 and/or microphone 470 included in the architecture 400. In some examples, the transfer application 424 may also be configured to send the received voice requests to one or more voice recognition servers.

In some examples, the storage element 402 may store instructions for executing all or some part of the system for unlearning data from language models 100. In various examples, some components of the system for unlearning data from language models 100 may be implemented using hardware (e.g., a field programmable gate array (FPGA), an application specific integrated circuit (ASIC), using software, and/or some combination of hardware and software.

When implemented in some user devices, the architecture 400 may also comprise a display component 406. The display component 406 may comprise one or more light-emitting diodes (LEDs) or other suitable display lamps. Also, in some examples, the display component 406 may comprise, for example, one or more devices such as cathode ray tubes (CRTs), liquid-crystal display (LCD) screens, gas plasma-based flat panel displays, LCD projectors, raster projectors, infrared projectors or other types of display devices, etc. As described herein, display component 406 may be effective to display content determined provided by a skill executed by the processing element 404 and/or by another computing device.

The architecture 400 may also include one or more input devices 408 operable to receive inputs from a user. The input devices 408 can include, for example, a push button, touch pad, touch screen, wheel, joystick, keyboard, mouse, trackball, keypad, light gun, game controller, or any other such device or element whereby a user can provide inputs to the architecture 400. These input devices 408 may be incorporated into the architecture 400 or operably coupled to the architecture 400 via wired or wireless interface. In some examples, architecture 400 may include a microphone 470 or an array of microphones for capturing sounds, such as voice requests. Voice recognition component 480 may interpret audio signals of sound captured by microphone 470. In some examples, voice recognition component 480 may listen for a “wakeword” to be received by microphone 470. Upon receipt of the wakeword, voice recognition component 480 may stream audio to a voice recognition server for analysis, such as a speech processing system. In various examples, voice recognition component 480 may stream audio to external computing devices via communication interface 412.

When the display component 406 includes a touch-sensitive display, the input devices 408 can include a touch sensor that operates in conjunction with the display component 406 to permit users to interact with the image displayed by the display component 406 using touch inputs (e.g., with a finger or stylus). The architecture 400 may also include a power supply 414, such as a wired alternating current (AC) converter, a rechargeable battery operable to be recharged through conventional plug-in approaches, or through other approaches such as capacitive or inductive charging.

The communication interface 412 may comprise one or more wired or wireless components operable to communicate with one or more other computing devices. For example, the communication interface 412 may comprise a wireless communication module 436 configured to communicate on a network, such as a computer communication network, according to any suitable wireless protocol, such as IEEE 802.11 or another suitable wireless local area network (WLAN) protocol. A short range interface 434 may be configured to communicate using one or more short range wireless protocols such as, for example, near field communications (NFC), Bluetooth, Bluetooth LE, etc. A mobile interface 440 may be configured to communicate utilizing a cellular or other mobile protocol. A Global Positioning System (GPS) interface 438 may be in communication with one or more earth-orbiting satellites or other suitable position-determining systems to identify a position of the architecture 400. A wired communication module 442 may be configured to communicate according to the USB protocol or any other suitable protocol.

The architecture 400 may also include one or more sensors 430 such as, for example, one or more position sensors, image sensors, and/or motion sensors. An image sensor 432 is shown in FIG. 4. An example of an image sensor 432 may be a camera configured to capture color information, image geometry information, and/or ambient light information.

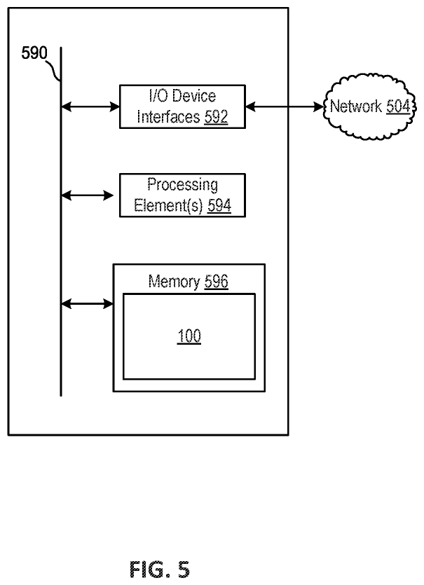

FIG. 5 is a block diagram conceptually illustrating example components of a remote device, such as a computing device executing a particular skill, a computing device executing one or more components of a speech processing system (e.g., ASR processing components, NLU processing components, applicable protocol recognition, etc.) and/or command processing. For example, the various components of FIG. 5 may be used to implement the system for unlearning data from language models 100 for unlearning data from language models. Multiple computing devices may be included in the system, such as one speech processing computing device for performing ASR processing, one speech processing computing device for performing NLU processing, one or more skill computing device(s) implementing skills, etc. In operation, each of these devices (or groups of devices) may include non-transitory computer-readable and computer-executable instructions that reside on the respective device, as will be discussed further below. The remote device of FIG. 5 may communicate with one or more other devices over a network 504 (e.g., a wide area network or local area network).

Each computing device of a speech processing system may include one or more controllers/processors 594, which may each include at least one central processing unit (CPU) for processing data and computer-readable instructions, and a memory 596 for storing data and instructions of the respective device. In at least some examples, memory 596 may store, for example, a list of N-best intents data that may be generated for particular request data. In some examples, memory 596 may store machine learning models of the LLM 80, such as machine learned models associated with various classifiers and/or natural language inference models (described in reference to FIG. 1), when loaded from memory 596. In various further examples, memory 596 may be effective to store instructions effective to program controllers/processors 594 to perform the various techniques described above in reference to FIGS. 1-3B. Accordingly, in FIG. 5, the system for unlearning data from language models 100 for unlearning data from language models is depicted as being stored within memory 596, as an example. The memories 596 may individually include volatile random access memory (RAM), non-volatile read only memory (ROM), non-volatile magnetoresistive memory (MRAM), and/or other types of memory. Each computing device of a speech processing system (and/or a component thereof) may also include memory 596 for storing data and controller/processor-executable instructions. Each memory 596 may individually include one or more non-volatile storage types such as magnetic storage, optical storage, solid-state storage, etc. Each computing device of a speech processing system may also be connected to removable or external non-volatile memory and/or storage (such as a removable memory card, memory key drive, networked storage, etc.) through respective input/output device interfaces 592. In various examples, the feature data and/or training data used by the various machine learning models may be stored and/or cached in memory 596.

Computer instructions for operating each computing device of a natural language processing system may be executed by the respective device's controllers/processors 594, using the memory 596 as temporary “working” storage at runtime. A device's computer instructions may be stored in a non-transitory manner in non-volatile memory 596 (e.g., a non-transitory computer-readable memory), memory 596, or an external device(s). Alternatively, some or all of the executable instructions may be embedded in hardware or firmware on the respective device in addition to or instead of software.

Each computing device of the various computing devices described herein may include input/output device interfaces 592. A variety of components may be connected through the input/output device interfaces 592, as will be discussed further below. Additionally, each computing device of a speech processing system may include an address/data bus 590 for conveying data among components of the respective device. Each component within a computing device of a speech processing system may also be directly connected to other components in addition to (or instead of) being connected to other components across the bus 590.

As noted above, multiple devices may be employed in a single system. In such a multi-device system, each of the devices may include different components for performing different aspects of the system's processing. The multiple devices may include overlapping components. The components of a speech processing system, as described herein, are exemplary, and may be located as a stand-alone device or may be included, in whole or in part, as a component of a larger device or system.

Various machine learning techniques may be used to train and operate models to perform various steps described herein, such as user recognition, sentiment detection, image processing, dialog management, etc. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

Although various systems described herein may be embodied in software or code executed by general purpose hardware as discussed above, as an alternate the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those of ordinary skill in the art and consequently, are not described in detail herein.

The flowcharts and methods described herein show the functionality and operation of various implementations. If embodied in software, each block or step may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processing component in a computer system. If embodied in hardware, each block may represent a circuit or a number of interconnected circuits to implement the specified logical function(s).

Although the flowcharts and methods described herein may describe a specific order of execution, it is understood that the order of execution may differ from that which is described. For example, the order of execution of two or more blocks or steps may be scrambled relative to the order described. Also, two or more blocks or steps may be executed concurrently or with partial concurrence. Further, in some embodiments, one or more of the blocks or steps may be skipped or omitted. It is understood that all such variations are within the scope of the present disclosure.

Also, any logic or application described herein that comprises software or code can be embodied in any non-transitory computer-readable medium or memory for use by or in connection with an instruction execution system such as a processing component in a computer system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as magnetic, optical, or semiconductor media. More specific examples of a suitable computer-readable media include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described example(s) without departing substantially from the spirit and principles of the disclosure. All such modifications and variations are intended to be included herein within the scope of this disclosure and protected by the following claims.

What is claimed is:

1. A computer-implemented method comprising:
determining a first language model (LM) trained on a first training corpus D;
determining first data F, wherein the first data F is a subset of D, and wherein the first data F is identified as a set of data to be unlearned by the first LM;
training a first n-gram language model using the first training corpus D;
training a second n-gram language model using a second training corpus D/F, wherein the second training corpus D/F represents the first training corpus D without the first data F;
determining a first text input of the first data F; and
updating the first LM to generate an updated LM based at least in part by:
minimizing a first prediction difference between a first prediction of the first LM and a second prediction of the second n-gram language model for the first text input; and
maximizing a second prediction difference between the first prediction of the first LM and a third prediction of the first n-gram language model for the first text input.

2. The computer-implemented method of claim 1, further comprising:
determining first loss comprising the first prediction difference;
determining second loss comprising the second prediction difference; and
generating the updated LM based at least in part by updating parameters of the first LM to decrease the first loss and to increase the second loss.

3. The computer-implemented method of claim 1, wherein:
the first prediction difference comprises a Kullback-Leibler divergence between a first probability distribution of the first LM for the first text input and a second probability distribution of the second n-gram language model for the first text input; and
the second prediction difference comprises the Kullback-Leibler divergence between the first probability distribution of the first LM for the first text input and a third probability distribution of the first n-gram language model for the first text input.

4. A method comprising:
determining a first language model (LM) trained on a first training corpus D;
determining first data F, wherein the first data F is a subset of D;
training a first auxiliary LM using the first training corpus D;
training a second auxiliary LM using a second training corpus D/F, wherein the second training corpus D/F represents the first training corpus D without the first data F;
determining a first text input; and
updating the first LM based at least in part on a first prediction difference between a first prediction of the first LM and a second prediction of the second auxiliary LM for the first text input and a second prediction difference between the first prediction of the first LM and a third prediction of the first auxiliary LM for the first text input.

5. The method of claim 4, further comprising updating the first LM based at least in part by updating parameters of the first LM to decrease the first prediction difference and increase the second prediction difference.

6. The method of claim 4, wherein a first number of parameters of the first LM is at least a magnitude greater than a second number of parameters of the first auxiliary LM.

7. The method of claim 4, further comprising determining the first prediction difference using a Kullback-Leibler divergence between a first probability distribution of the first LM for the first text input and a second probability distribution of the second auxiliary LM for the first text input.

8. The method of claim 4, wherein the first auxiliary LM is a first n-gram LM and the second auxiliary LM is a second n-gram LM.

9. The method of claim 4, wherein the second auxiliary LM is a language model trained on a dataset comprising public domain text data.

10. The method of claim 4, further comprising:
partitioning the first training corpus D into n training partitions;
training a first plurality of auxiliary models using the n training partitions, wherein each auxiliary model of the first plurality of auxiliary models is trained using a respective one of the n training partitions; and
generating the second auxiliary LM by aggregating the first plurality of auxiliary models.

11. The method of claim 10, wherein data of the n training partitions excludes the first data F.

12. The method of claim 4, further comprising:
determining a reinforcement learning policy with a reward term that rewards the first LM for generating outputs that are statistically similar to outputs of the second auxiliary LM and a penalty term that penalizes the first LM for generating outputs that are statistically similar to outputs of the first auxiliary LM for a given input, wherein statistical similarity is determined using a first statistical similarity metric.

13. A system comprising:
at least one processor; and
non-transitory computer-readable memory storing instructions that, when executed by the at least one processor, are effective to:
determine a first language model (LM) trained on a first training corpus D;
determining first data F, wherein the first data F is a subset of D;
training a first auxiliary LM using the first training corpus D;
train a second auxiliary LM using a second training corpus D/F, wherein the second training corpus D/F represents the first training corpus D without the first data F;
determine a first text input; and
update the first LM based at least in part on a first prediction difference between a first prediction of the first LM and a second prediction of the second auxiliary LM for the first text input and a second prediction difference between the first prediction of the first LM and a third prediction of the first auxiliary LM for the first text input.

14. The system of claim 13, the non-transitory computer-readable memory storing further instructions that, when executed by the at least one processor, are further effective to:
update the first LM based at least in part by updating parameters of the first LM to decrease the first prediction difference and increase the second prediction difference.

15. The system of claim 13, wherein a first number of parameters of the first LM is at least a magnitude greater than a second number of parameters of the first auxiliary LM.

16. The system of claim 13, the non-transitory computer-readable memory storing further instructions that, when executed by the at least one processor, are further effective to:
determine the first prediction difference using a Kullback-Leibler divergence between a first probability distribution of the first LM for the first text input and a second probability distribution of the second auxiliary LM for the first text input.

17. The system of claim 13, wherein the first auxiliary LM is a first n-gram LM and the second auxiliary LM is a second n-gram LM.

18. The system of claim 13, wherein the second auxiliary LM is a language model trained on a dataset comprising public domain text data.

19. The system of claim 13, the non-transitory computer-readable memory storing further instructions that, when executed by the at least one processor, are further effective to:
partition the first training corpus D into n training partitions;
train a first plurality of auxiliary models using the n training partitions, wherein each auxiliary model of the first plurality of auxiliary models is trained using a respective one of the n training partitions; and
generate the second auxiliary LM by aggregating the first plurality of auxiliary models.

20. The system of claim 19, wherein data of the n training partitions excludes the first data F.
